(19) United States
(12) Patent Application Publication
(10) Pub. No.: US 2005/0243978 A1
(43) Pub. Date: Nov. 3, 2005

(54) System and method of interworking messages between mobile communication terminals

(75) Inventors: Sung-Mu Son, Gyeonggi-Do (KR); Young-Ae Kim, Daegu (KR); Kang-Suk Huh, Gyeonggi-Do (KR); Te-Hyun Kim, Gyeonggi-Do (KR); Hee-Joung Lee, Gyeonggi-Do (KR); Dong-Hee Shim, Seoul (KR)

Correspondence Address: LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/107,486

(22) Filed: Apr. 14, 2005

Related U.S. Application Data
(60) Provisional application No. 60/561,918, filed on Apr. 14, 2004.
(60) Provisional application No. 60/564,609, filed on Apr. 23, 2004.

(30) Foreign Application Priority Data
Apr. 14, 2004 (KR) 10-2004-025959
Jan. 26, 2005 (KR) 10-2005-007294

(51) Int. Cl. H04M 11/00; H04M 1/64

(52) U.S. Cl. 379/88.13; 379/88.22

(57) ABSTRACT

A system for interworking messages of a mobile communications terminal employs a method of receiving by a first messaging service server a multimedia message sent by a first user client of a first messaging service, processing the multimedia message at the first messaging service server and at a second messaging service server, and providing by the second messaging service server the processed multimedia message to a second user client of a second messaging service. The message includes a parameter that indicates the originating messaging service type or the recipient messaging service type as a field or an indicator in the header portion or body portion of the message.

### CROSS REFERENCE TO RELATED APPLICATIONS

The present application claims the benefit of Korean patent application number 10-2004-025959 filed Apr. 14, 2004 and Korean patent application number 10-2005-007294 filed Jan. 26, 2005, the disclosures of which are incorporated herein by reference, and the benefit of U.S. provisional application No. 60/561,918 filed Apr. 14, 2004 and U.S. provisional application No. 60/564,609 filed Apr. 23, 2004, the disclosures of which are incorporated herein by reference.

### BACKGROUND ART

The present invention relates to a messaging service for a mobile communications terminal, and in particular, to a system and method for interworking messages of a mobile communications terminal that receives multimedia contents transmitted by using an instant messaging (IM) client.

Recently, many users of mobile communications terminals use their terminals to send and receive text messages, and the size of the market for text-based message services is consistently increasing in addition to voice communications.

Message services for mobile communication terminals can be broadly divided into instant message (IM) services, multimedia message services (MMS), and short message services (SMS). As instant message clients are being installed in mobile communication terminals, instant message services based on wired Internet technology are being expanded into the field of mobile communications.

An instant message service generally provides the user of the terminal with high-speed conversation-type communication means, such as text-based messages. Here, the instant message client includes so-called “presence services” that can notify the user about various operation information, such as the party that is connected with the user, the on-line status of the client, the possibility of replies, and the like.

The multimedia message service is a message service that transmits text messages together with videos, combined images, background music, and the like that are desired by the user. However, such transmissions are performed without considering the state (status) of the message recipient.

The related art message service system for a mobile communication terminal allows message services between mobile communication terminals having the same message client installed therein, but has the problem of not being able to provide message services between mobile communication terminals having different messages clients installed therein.

### SUMMARY OF THE INVENTION

The present invention provides a system and method that allows interworking (compatibility) among mobile communication terminals that support different types of messaging services, whereby multimedia contents transmitted by using an instant message client can be received by a multimedia message client at the receiving end (e.g., receiving terminal).

### PURPOSE OF THE INVENTION

In order to satisfy the continuing development of mobile and wireless communication technologies, the present invention provides compatibility between user terminals (mobile handsets, wireless access devices, etc.) that have different capabilities and support various types of messaging services such that a user of one type of messaging service may send messages to a user of another type of messaging service.

### BRIEF DESCRIPTION OF THE DRAWINGS

FIG. 1 depicts an exemplary structure of a system for mobile communications terminal message service interworking according to the present invention.

FIG. 2 depicts a block diagram of an exemplary structure of an instant message server according to the present invention.

FIG. 3 depicts a block diagram of an exemplary structure of a multimedia message service center according to the present invention.

FIG. 4 depicts a block diagram of an exemplary structure of a mobile core network according to the present invention.

FIGS. 5A and 5B depict flow charts of an exemplary method of interworking mobile communications terminal messages according to the present invention.

FIGS. 6A through 6C depict an exemplary embodiment for checking whether a multimedia message service client of a receiver terminal exists by using an instant message client of a transmitting terminal according to the present invention.

FIG. 7 depicts a flow of signals of a system for interworking mobile communication terminal messages according to an embodiment of the present invention.

FIGS. 8A and 8B depict structures of the basic architecture of an interworking of messaging services according to embodiments of the present invention.

FIG. 9 depicts a flow chart of a method for interworking of messaging services according to an embodiment of the present invention.

FIG. 10 depicts a flow chart of a method for interworking of messaging services according to an embodiment of the present invention using a recipient messaging service field and an originating messaging service field.

FIG. 11 depicts a signal flow for a method of interworking between respectively different messaging systems in a first embodiment of the present invention.

FIG. 12 depicts a signal flow for a method of interworking between respectively different messaging systems in a second embodiment of the present invention.

FIG. 13 depicts a signal flow for a method of interworking between respectively different messaging systems in a third embodiment of the present invention.

FIG. 14 depicts a signal flow for a method of interworking between respectively different messaging systems in a fourth embodiment of the present invention.

FIG. 15 depicts a signal flow for a method of interworking between respectively different messaging systems in a fifth embodiment of the present invention.

FIG. 16 depicts a signal flow for a method of interworking between respectively different messaging systems in a sixth embodiment of the present invention.

FIG. 17 depicts a format of a message having a recipient messaging service field and an originating messaging service field according to the present invention.

FIG. 18 depicts an example of a SIP message header format according to the present invention.

FIG. 19 depicts an example of a RTP message header format according to the present invention.

FIG. 20 depicts an example of a RTCP message header format according to the present invention.

### DETAILED DESCRIPTION

The present invention provides a system for interworking messages of a mobile communication terminal in which a transmitting terminal having a first message client installed therein for transmitting multimedia contents to a receiving terminal having a second message client installed therein, the system comprises, a first server that checks whether the multimedia contents can be transmitted to the receiving terminal; a second server that converts a format of the multimedia contents transmitted from the first server into a contents format supported by the receiving terminal; and a mobile core network that collects information related to the terminals, and provides information requested by the first server, the second server, and each terminal.

Also, a system for mobile communication terminal message interworking according to the present invention comprises, a transmitting terminal that transmits multimedia contents by using a first message client; a receiving terminal that receives the multimedia contents by using a second message client; a first server that checks the receiving address of the multimedia contents and checks a message client installed in the receiving terminal; a second server that converts a format of the multimedia contents transmitted from the first server into a format supported by the receiving terminal and that transmits the multimedia contents upon request from the receiving terminal; and a mobile core network that collects information related to the terminals, and provides information requested by the first server, the second server, and each terminal.

A method for mobile communication terminal message interworking according to the present invention comprises, determining a path for transmitting multimedia contents according to a service supported by a message client installed in a receiving terminal; and transmitting to the receiving terminal upon converting the multimedia contents into a format that is supported by the receiving terminal.

Also, a method for mobile communication terminal message interworking according to the present invention comprises, transmitting multimedia contents to a first server upon activating a first message client installed in a transmitting terminal; checking an address of a receiving terminal and a second message client installed in the receiving terminal; informing from a second server, reception of the multimedia contents of the receiving terminal; converting a format of the multimedia contents into a contents format supported by the receiving terminal, upon transmission of a reception request from the receiving terminal; and transmitting the multimedia contents to the receiving terminal.

Hereafter, exemplary embodiments of the system and method for interworking mobile communication terminal messages according to the present invention will be explained with reference to the drawings.

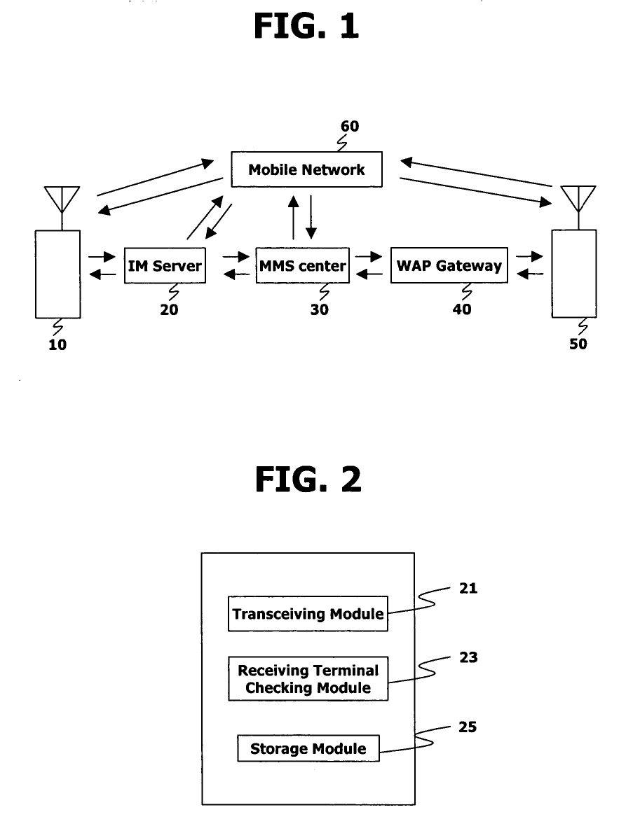

Here, it is important to note that all of the entities specified in FIGS. 1 through 4 may not be necessary, such as the WAP gateway (described below), in achieving the present invention, because many other types of network entities may also perform the desired operations and different operations and processing may also be combined and performed within a single entity. Those skilled in the art can clearly understand that the particular network entities described hereafter are only exemplary, and are used to explain the features of the present invention, which may also be achieved by various other types of equivalent hardware, software, and/or any combination of hardware and software.

FIG. 1 depicts an exemplary structure of a system for mobile communications terminal message service interworking according to the present invention, whereby the system is for interworking between an instant message service terminal and a multimedia message service terminal.

As shown in FIG. 1, the system comprises a transmitting terminal (10) that stores and transmits multimedia contents formed by a user; an instant message server (20) that checks whether the multimedia contents transmitted from the transmitting terminal (10) can be transmitted to a receiving terminal (50); a multimedia message service (MMS) center (30) that checks a format and codec of the multimedia contents transmitted from the instant message server (20) and converts such into a contents format supported by the receiving terminal (50); a WAP gateway (40) that notifies the receiving terminal (50) when the multimedia contents are inputted to the multimedia message service center (30); a receiving terminal (50) that requests the notified multimedia contents from the multimedia message service center (30) through the WAP gateway (40), and receives the requested multimedia contents through the WAP gateway (40); and a mobile core network (60) that performs authentication and authorization, and performs periodic or non-periodic updating of information from the transmitting terminal (10) and the receiving terminal (50). Here, the instant message server (20) is a first server for processing instant messages, and the multimedia message service center (30) is a second server for processing multimedia message services.

The transmitting terminal (10) is a mobile communication terminal having an instant message client installed therein, and the receiving terminal (50) is a mobile communication terminal having a multimedia message service client (and not an instant message client) installed therein.

The instant message server (20) allows transmission of multimedia contents upon request from the transmitting terminal (10), and checks the information stored in the mobile core network (60) to determine whether the receiving terminal (50) to which the multimedia contents are to be transmitted has an instant message client or a multimedia message service client installed therein.

FIG. 2 depicts a block diagram of an exemplary structure of an instant message server according to the present invention, comprising a transceiving module (21) that receives multimedia contents and the like transmitted from the transmitting terminal (10) and transmitting such to a different server; a receiving terminal checking module (23) that performs addressing resolution for the destination of the multimedia contents to be transmitted and checks from the mobile core network (60) as to whether the receiving terminal (50) has a multimedia message server client installed therein; and a storage module (25) that temporarily stores the multimedia contents transmitted from the transmitting terminal (10).

The multimedia message service center (30) determines whether the format/codec of the multimedia contents received from the instant message server (20) is supported by the receiving terminal (50). If the format/codec of the multimedia contents is supported, the multimedia contents are not converted but transmitted directly to the receiving terminal (50), but if the format/codec of the multimedia contents is not supported, the multimedia contents are converted to a format/codec that is appropriate for the receiving terminal (50) and then transmitted.

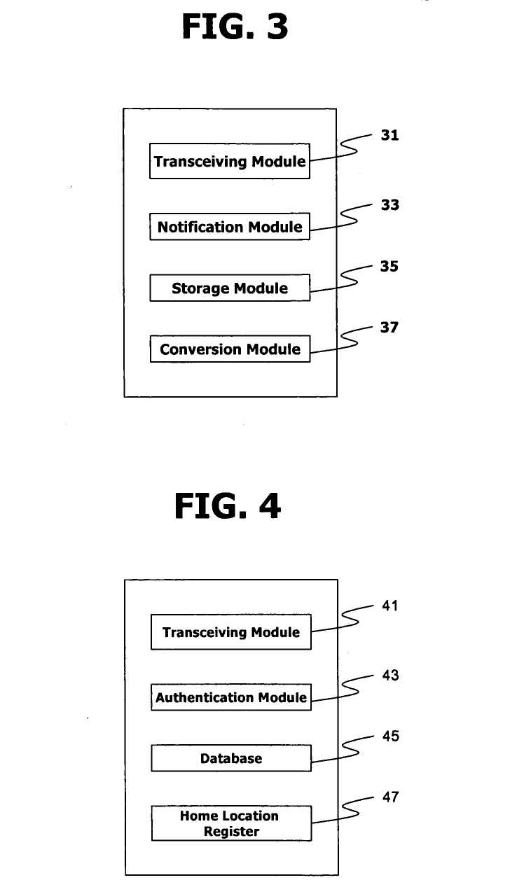

FIG. 3 depicts a block diagram of an exemplary structure of a multimedia message service center according to the present invention comprising, a transceiving module (31) that receives multimedia contents from the instant message server (20) and transmits the multimedia contents that have been appropriately converted for the receiving terminal (50) to a different server or to the receiving terminal (50); a notification module (33) that notifies reception of the multimedia contents to the receiving terminal (50); a storage module (35) that temporarily stores the received multimedia contents; and a conversion module (37) that checks the format/codec of the received multimedia contents and converts the multimedia contents according to the capabilities of the receiving terminal (50).

The mobile core network (60) is a generic user profile (GUP) server of the 3GPP TS 23.240, that employs a simple mail transfer protocol (SMTP) for exchanging information with the instant message server (20) and the multimedia message service center (30). Here, the mobile core network is defined in the wireless village interpersonal messaging system (IMPS) of the Open Mobile Alliance (OMA) standard.

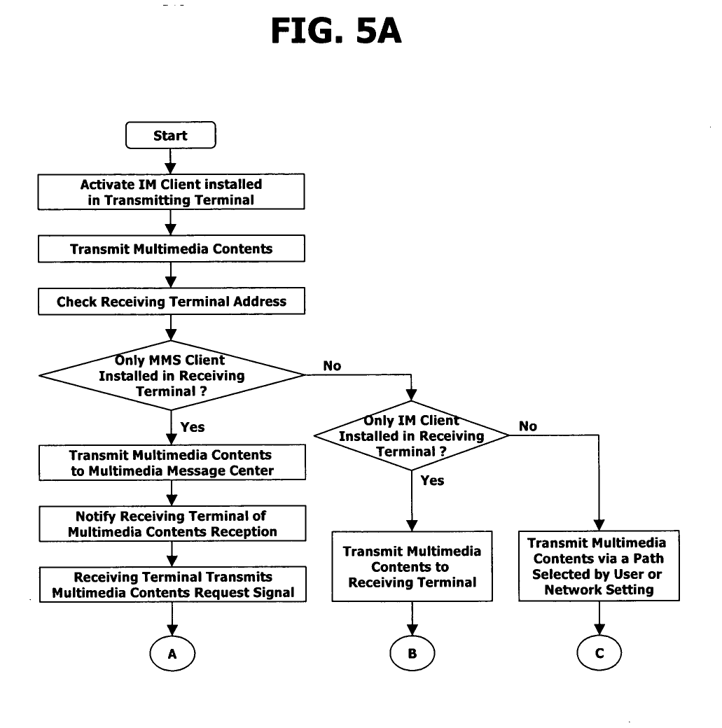

FIG. 4 depicts a block diagram of an exemplary structure of a mobile core network according to the present invention, comprising a transceiving module (61) that receives information request signals from the instant message server (20) or the multimedia message service enter (30) or a terminal, or transmits certain information; an authentication module (63) that performs authentication and authorization for each comprising element of the system or for each subscriber; a database (65) that stores and periodically or non-periodically updates user terminal service subscription information, user profile information, presence information, access rights information, and the like; and a home location register (HLR) (67) that manages network information of the terminal.

The operations of the system for interworking mobile communication terminal message services having the above-identified structure will be described hereafter.

When a sender inputs and transmits multimedia contents through an instant message client of a transmitting terminal (10), the multimedia contents are inputted into the instant message server (20).

The instant message server (20) checks the address of the destination to which the multimedia contents are to be transmitted, and upon performing addressing resolution, checks whether the receiving terminal 950) has a multimedia message service client (and not an instant message client) installed therein, and then transmits the multimedia contents to the multimedia message service center (30).

The multimedia message service center (30) checks the format/codec of the transmitted multimedia contents, to determine whether the receiving terminal (50) supports that format/codec. If the format/codec of the multimedia contents are of the type that is supported by the receiving terminal (50), the multimedia contents are not converted but transmitted directly to the receiving terminal (50), and if not the type supported by the receiving terminal (50), the multimedia contents are converted to a type that is supported by the receiving terminal (50) and then transmitted.

The multimedia contents are transmitted to the receiving terminal (50) through the WAP gateway (40), and the recipient may check the contents of the transmitted multimedia contents by using the multimedia message service client installed in the receiving terminal (50).

Namely, according to the mobile communication terminal message interworking system of the present invention, even if a multimedia message service client is installed in the receiving terminal (50) instead of an instant message client, the receiving terminal (50) can receive the multimedia contents transmitted by a transmitting terminal (10) that uses an instant message client. Here, the transmitting terminal (10) and the instant message server (20) receive from the mobile core network (60), information that the receiving terminal (50) does not have an instant message client installed therein, but only has a multimedia message service client installed therein.

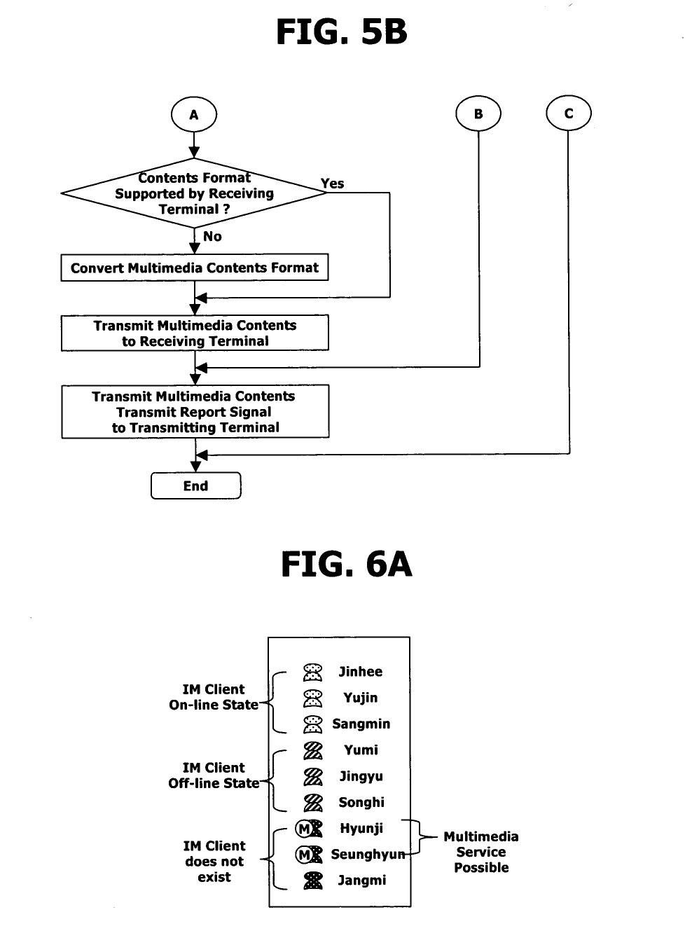

FIGS. 5A and 5B depict flow charts of an exemplary method of interworking mobile communications terminal messages according to the present invention.

Initially, the sender activates the instant message client installed in the transmitting terminal (10) and checks the message client installed in the receiving terminal (50) (S11). Here, the transmitting terminal (10) has installed therein, the same instant message client as that in the receiving terminal (50) or has only a multimedia message service client (that is not an instant message client) installed therein, or has both an instant message client and a multimedia message client installed simultaneously therein.

In the present invention, it is assumed that the transmitting terminal (10) has an instant message client installed therein and the receiving terminal (50) has a multimedia message service client installed therein.

After the sender creates the multimedia contents by using the instant message client, the multimedia contents are transmitted to the receiving terminal (50) (S12). Here, if other contents besides the multimedia contents are to be transmitted, the transmitting terminal (10) can inform the sender that such contents cannot be sent. This is because the multimedia message service client installed in the receiving terminal (50) can only receive multimedia contents, and thus if the sender attempts to transmit other types of contents, the transmitting terminal (10) can generate an alarm to inform the sender.

The instant message server (20) that received the multimedia contents checks the address of the receiving terminal (50) (S13), receives the information of the receiving terminal (50) provided from the mobile core network (60), and then checks whether only a multimedia message service client is installed in the receiving terminal (50) (S14).

Upon determining whether an instant message client is installed in the receiving terminal (50) (S15), if an instant message client is not installed but only a multimedia message service client is installed, the instant message server (20) transmits the multimedia contents to the multimedia message service center (30) (S16).

If an instant message client is installed in the receiving terminal (50), the multimedia contents are transmitted to the receiving terminal (50) through the WAP gateway (40) (S17), and if both an instant message client and a multimedia message service client are installed in the receiving terminal (50), the multimedia contents are transmitted according to the user's selection or network settings (S18). Here, it is determined whether the multimedia contents are to be transmitted to the instant message client or to the multimedia message service client according to the user's selection or the network settings.

The multimedia message service center (30) temporarily stores the multimedia contents, and informs the receiving terminal (50) through the WAP gateway (40) by transmitting a short message to indicate that the multimedia contents were received (S19).

When the recipient operates his receiving terminal (50) to request reception of the multimedia contents through the WAP gateway (40), the request signal is transmitted to the multimedia message service center (30) via the WAP gateway (40) (S20).

The multimedia message service center (30) receiving the request signal checks whether the format/codec of the multimedia contents are supported by the receiving terminal (50) (S21).

If the format/codec of the multimedia contents are not supported by the receiving terminal (50), the contents are converted into a contents format that is supported by the receiving terminal (50) (S22), and if the format/codec are supported, then the format of the multimedia contents are not converted.

The multimedia message service center (30) transmits the multimedia contents that have or have not been converted to the receiving terminal (50) via the WAP gateway (40) (S23).

The receiving terminal (50) that receives the multimedia contents transmits to the transmitting terminal (10), a delivery report signal indicating that the contents have been received (S24).

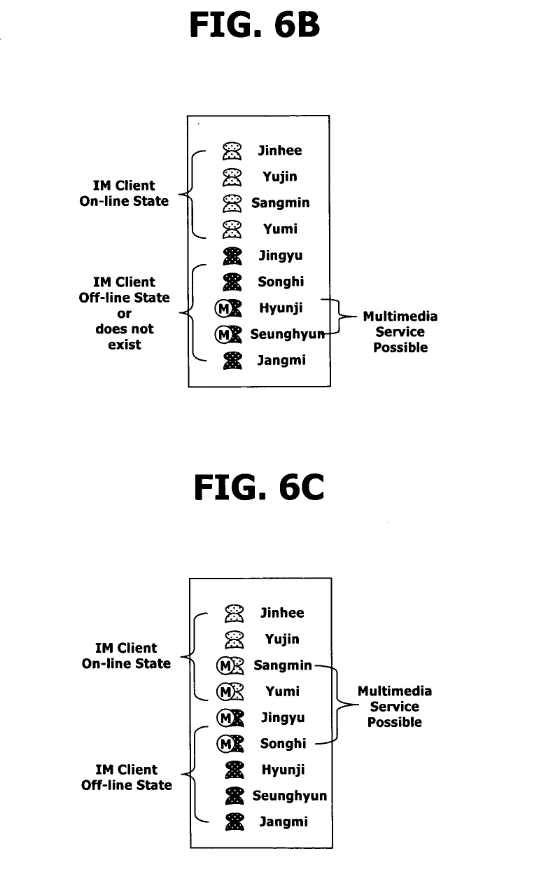

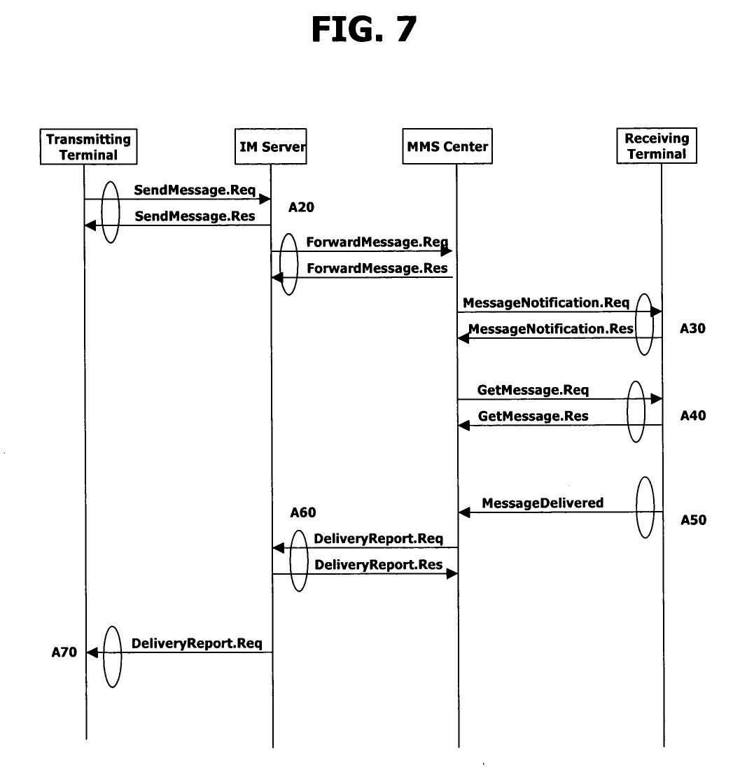

FIGS. 6A through 6C depict an exemplary embodiment for checking whether a multimedia message service client of a receiver terminal (50) exists by using an instant message client of a transmitting terminal (10) according to the present invention. Special characters such as subscripts or superscripts, or colors may be used to distinguish users (receiver terminals).

Here, each icon displayed on the instant message client refers to a recipient or receiving terminal (50).

FIG. 6A depicts an example in which the on-line or off-line states of receiving terminals (50) that have an instant message client installed therein, and those receiving terminals (50) that do not have an instant messaging client installed therein can be indicated in different colors. Also, among the receiving terminals (50) that do not have an instant message client installed therein, those that have a multimedia message service client installed therein can be indicated with a letter “m” to indicate that multimedia message service would be possible with that terminal.

FIG. 6B depicts an example in which the on-line or off-line states of receiving terminals (50) that have an instant message client installed therein are indicated in different colors, and the receiving terminals (50) that do not have an instant message client installed therein are indicated in the same color as those receiving terminals (50) having an instant message client therein but that are in off-line state. Also, among the receiving terminals (50) that do not have an instant message client installed therein, those that can support a multimedia message service can be indicated with a letter “m” to indicate that multimedia message service would be possible with that terminal.

FIG. 6C depicts an example in which the instant message client employs special characters (such as subscripts) to distinguish various types of services supported by the receiving terminal (50), such as multimedia message services, instant message services, location services, and the like. The n-line and off-line states for the instant service are distinguished by different colors, and the receiving terminals (50) the can support multimedia message service can have a subscript “m” added thereto to indicate that multimedia message service is possible. Here, the subscript “m” can be added to all receiving terminals that can support multimedia message services regardless of the on-line or off-line states of their instant message clients.

As a method for checking whether or not a multimedia message client is installed in a receiving terminal, in addition to the method of checking the colors or subscripts of the icons as described above, a method of checking the registration information of the corresponding icons in the receiving terminal may also be used. Namely, because the icons also contain registration information that includes information about the message client installed in the corresponding receiving terminal, the user can select a certain icon to check its registration information in order to check whether the receiving terminal has a multimedia message client installed therein.

FIG. 7 depicts a flow of signals of a system for interworking mobile communication terminal messages according to the present invention.

As shown in FIG. 7, when the transmitting terminal (10) uses its instant message client for transmitting a multimedia contents transmit signal (SendMessage.Req) to the instant message server (20), the instant message server (20) transmits to the transmitting terminal (10) a response signal (Send Message.Res) with respect to the multimedia contents signal (A10).

The instant message server (20) that received the multimedia contents from the transmitting terminal (10) transmits a multimedia contents transmit signal (ForwardMessage.Req) to the multimedia message service center (30), and receives a response signal (ForwardMessage.Res) with respect to the transmit signal from the multimedia message service center (30) (A20).

The multimedia service center (30) that received the multimedia contents from the instant message server (20) transmits a notification signal (MessageNotification.Req) to the receiving terminal (50) to indicate that the multimedia contents have been received, and receives a response message (MessageNotification.Res) with respect to the notification signal (A30).

The receiving terminal (50) that received the notification signal transmits a multimedia contents request signal (GetMessage.Req) to the multimedia message service center (30), and receives a response signal (GetMessage.Res) that includes the multimedia contents (A40).

The receiving terminal (50) receiving the multimedia contents stored in the multimedia message service center (30) transmits a transmit complete signal (MessageDelivered) to the multimedia message service center (30) (A50), which then transmits a transmit report signal (DeliveryReport.Req) to the instant message server (20).

The instant message server (20) the received the transmit report signal transmits a response signal (DeliveryReport.Res) to the multimedia message service center (30) (A60), and transmits to the transmitting terminal (10) a transmit report signal (DeliveryReport.Req) that indicates the completion of the multimedia contents transmission (A70).

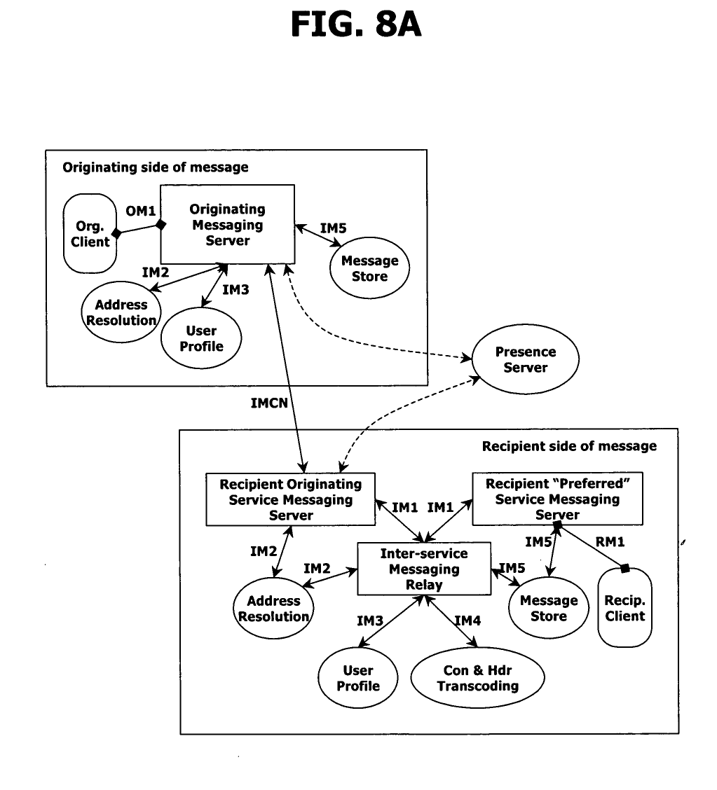

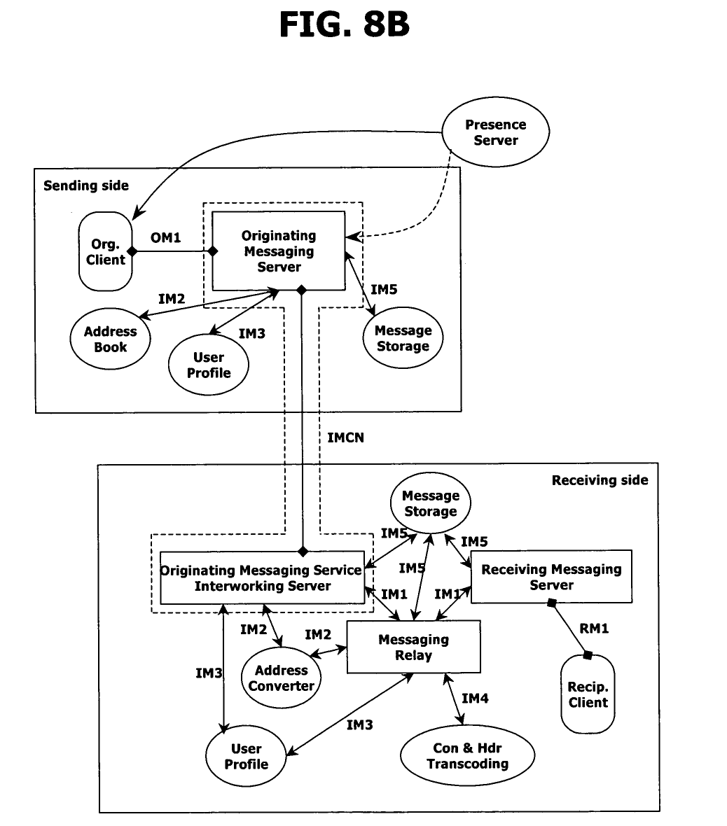

FIG. 8A depicts a structure of a basic architecture of an interworking of messaging services according to the present invention. A block diagram of the logical entities that may comprise the interworking of different messaging services is shown, and the details of each entity will be described.

The (inter-service) messaging relay (MR) is a logical entity responsible for the transfer of a message between two messaging services. Such responsibilities include, identifying the target messaging service based upon the address-resolution and recipient user-profile, conversion of the message format to he accepted format of the recipient messaging service, and producing the proper billing records for he transfer to the target messaging service.

In more detail, the MR interfaces with the different messaging servers (and may be implemented as part of a messaging server) to transfer the message information (both content and “envelope”) between different services. In addition, it interfaces to he basic enablers for address resolution, accessing the user-profile, and receiving and storing he message in persistent storage. The MR is responsible for various functionalities, including the support of varied protocols such as (but not exclusively) MM4, MM7, SMTP, various SIP-based protocols, etc.; and accepting messages to be transferred to a different messaging server, wherein the message may either be supplied explicitly or be accessed through a link to network storage. Other responsibilities include identifying the target messaging service, which may be supplied explicitly by the originating messaging service or ascertained from the recipient's user-profile; performing message conversion and adaptation to render in the target messaging service formats; maintaining the message in persistent storage until the message has been successfully delivered to the target messaging service; managing the forwarding of delivery and read reports that may be routed back from the recipient messaging service to the originator of the message upon request and where supported by both the originating and recipient messaging services; and maintaining the privacy and security of the messaging services.

The address resolution (AdR) is a logical entity responsible for completion of the abbreviated address to be a fully qualified address according to the address format used by the destination messaging service. In more detail, the AdR is an interface between a messaging server or the messaging relay (MR) and the address book that allows the expansion of a given recipient address to the fully qualified address that identifies the recipient messaging service and destination server for the message delivery. The interface should support the input of any address format, including shortened “nick-names” and an indication of the desired format of fully qualified format, and return the fully qualified address or an indication that no such address is available for the supplied input.

The user profile is a logical entity that defines certain information that should be defined within the profile of users that subscribe to messaging services and should be accessible to the messaging servers and the messaging relay (MR). In more detail, the user profile provides both an interface between the messaging server (or MR) and the database of user information within the operator's domain as well as a specified set of user parameters that indicate a minimal set of attributes. The attributes should include at least certain types of information, such as a list of messaging services that the user is subscribed to, a list of “preferred” messaging services that the user would define to receive different media types, and basic messaging parameters.

The content & header transcoding is a logical entity that provides services of transcoding either the content of a message or a header formats between the formats of different messaging services. In more detail, the transcoding services provide services to the messaging server or the MR to perform adaptation of the content and message format. This may be supported by an extended version of the Standard Transcoding Interface (STI). Extensions should allow transformation of header information and not only the content information that is currently supported.

The message store (storage) is a logical entity that provides persistent storage of messages in the network that may be accessed by the messaging servers and the messaging relay (MR) to store and retrieve the message being sent. In more detail, the message storage provides persistent storage for messages that should be accessible across all messaging services provided by the operator. In particular, the message storage should provide an interface that allows storage of messages in various formats (e.g., e-mail, multimedia messages (MM), short message service (SMS), etc.), generation of URI for the messages, retrieval and replacement of the message in the storage based on a URI, and management of the storage by the messaging servers or the MR.

Between such various network entities, there are reference points (e.g., interfaces) that are necessary. The following Table 1 lists each reference point and its relevant description.

TABLE 1

| Reference | | |
|---|---|---|
| Point | Between Entities | Description |
| OM1 | Originating Client & | Reference point internally |
| | Server | specified by the originating |
| | | messaging service. |
| RM1 | Recipient Server & | Reference point internally |
| | Client | specified by the recipient |
| | | messaging service. |
| IM1 | Messaging Server & MR | Interface that allows a messaging |
| | | server to invoke he MR |
| | | functionality and allows the MR to |
| | | transfer the message o recipient |
| | | messaging server. |
| IM2 | Messaging server/relay | Interface hat supports address |
| | & AdrR | resolution functionality and |
| | | provides the messaging server |
| | | with translation of addresses o |
| | | different formats. |
| IM3 | Messaging server/relay | Interface that supports retrieval of |
| | & User Profile | user configuration information. |
| IM4 | Messaging server/relay & | Standard transcoding interface - |
| | Content/Header | not only addresses content |
| | Transcoding | information but also the format of |
| | | the message. |
| IM5 | Messaging server/relay | Interface that supports the |
| | & message store | storage, retrieval, and |
| | | maintenance of messages in a |
| | | network based permanent |
| | | storage. |
| IMCN | Messaging servers in | Reference point internally |
| | separate networks | specified by originating messaging |
| | | service to transfer messages |
| | | between servers in different |
| | | networks. |

FIG. 8B depicts a structure of a basic architecture of an interworking of messaging services according to the present invention. Like in FIG. 8A, a block diagram of the logical entities that may comprise the interworking of different messaging services and the interfaces (reference points) therebetween are shown, but the details of the different features will be explained.

The sending side and the receiving side of FIG. 8B and the originating side and the recipient side of FIG. 8A respectively have equivalent logical entities. For example, the sending messaging service interworking server and the receiving messaging server in FIG. 8B respectively correspond to the recipient originating service message server and the recipient “preferred” service messaging server in FIG. 8A. However, in FIG. 8B, it is shown that the originating messaging server and the sending messaging service interworking server may be part of the same logical entity. Namely, a single server may serve the functions of both servers, as indicated by the dotted lines in FIG. 8B.

Also, the address resolution and message store in FIG. 8A respectively correspond to the address converter and message storage in FIG. 8B. Additionally, the presence server in FIG. 8A cooperates with the originating messaging server and the recipient originating service messaging server, while the presence server in FIG. 8B cooperates with the originating client and the originating messaging server. Furthermore, in the recipient side of FIG. 8A, the message store is connected to the inter-service messaging relay and the recipient “preferred” service messaging server, while in the receiving side of FIG. 8B, the message storage is connected with the sending messaging service interworking server, the messaging relay, and the receiving messaging server.

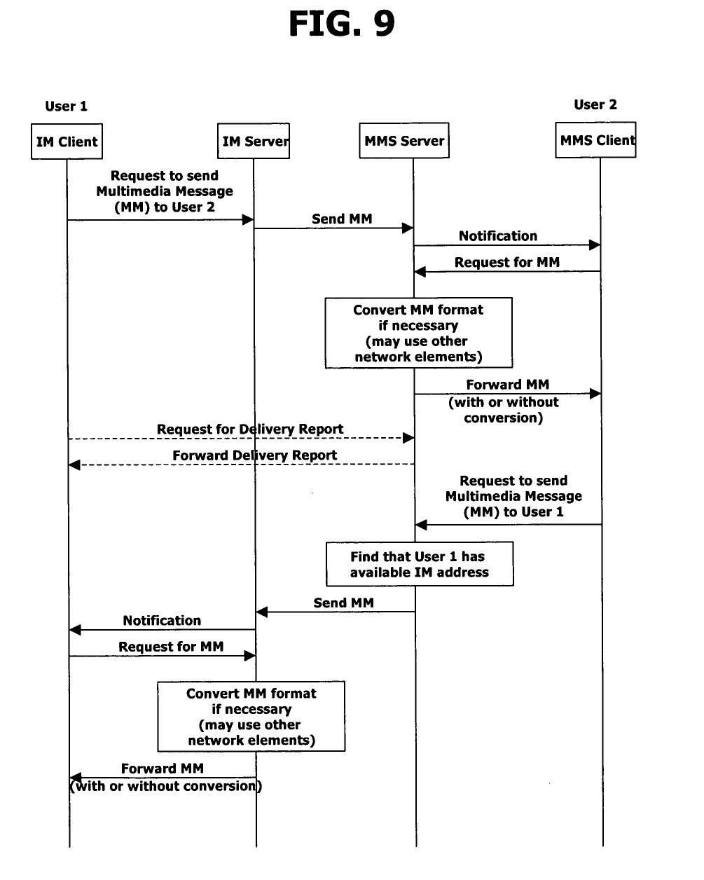

FIG. 9 depicts a flow chart of a method for interworking of messaging services according to the present invention.

Referring to FIGS. 8A, 8B and 9, the present invention also provides a method of interworking between different messaging systems, the method comprising: sending by a terminal to an originating messaging server, a message including recipient preferred messaging service type; receiving the message by a recipient originating service messaging server; and sending a transcoded message to a recipient preferred service messaging server, by considering the received message including recipient preferred messaging service type, without checking any other network entity to get information about the recipient preferred messaging service type.

In other words, the transcoded message is sent to a recipient preferred service messaging server, without having to check other network entities such as a user profile to find the recipient preferred messaging service type, because only the received message including recipient preferred messaging service type needs to be considered.

Here, the step of sending the message including recipient preferred messaging service type further comprises the steps of performing address resolution, checking a user profile, and storing the message prior to sending. Also, the step of sending the transcoded message further comprises a step of converting the received message having a first format into a second format to allow compatibility between different types of messaging services. Additionally, the originating messaging server receives from a presence server, state information and possible service applications related to a recipient terminal prior to sending the message including recipient preferred messaging service type.

Furthermore, the present invention provides a method of interworking between different messaging systems, the method comprising: receiving a message related to a messaging service; obtaining preferred messaging service type of a recipient; inserting in the received message, at least one parameter related to the obtained preferred messaging service type; and sending the received message having the parameter inserted therein to a recipient originating service messaging server.

This method can further comprise a step of finding a destination messaging system which the received message should be routed to, wherein the preferred messaging service type is obtained from a presence server or a user profile, wherein the at least one parameter is for sending or receiving a message of the preferred messaging service, and wherein the at least one parameter includes one parameter for sending a message of the preferred messaging service and another parameter for receiving a message of the preferred messaging service.

Also, the present invention provides a method of interworking between different messaging systems, the method comprising: receiving a message having a parameter therein that indicates a preferred messaging service type; processing the message according to the parameter into a format supported by the preferred messaging service; and providing the message to a recipient of the preferred messaging service.

Here, the message can be received by a recipient originating service messaging server in a format that is different from the format of the preferred messaging service; and the processing step can include a step of performing address resolution; and the messages can be processed via a messaging relay for checking of a user profile, performing content and header transcoding, and storing the messages; and the messages can be provided to the recipient via a recipient preferred service messaging server.

Additionally, the present invention provides a messaging service method, comprising: sending a message from an originating client to an originating messaging server; storing the message in a message storage; obtaining user information through a presence server or a user profile, wherein the information contains at least a preferred messaging service type; finding a next server through address resolution; sending the message to the next server; transcoding an originating message format into a recipient message format; finding a recipient preferred service messaging server through address resolution; sending the transcoded message to the recipient preferred service messaging server; storing the transcoded message and sending a notification to the recipient client; requesting to receive the transcoded message to the recipient preferred service messaging server; and receiving the transcoded message.

Furthermore, the present invention provides a messaging service method comprising: receiving by a first messaging service server, a multimedia message sent by a first user client of a first messaging service; processing the multimedia message at the first messaging service server and at a second messaging service server; and providing by the second messaging service server, the processed multimedia message to a second user client of a second messaging service.

Here, the processing can modify the contents or the format of the multimedia message to allow compatibility between the first and second messaging services, and wherein the first messaging service is an instant message service and the second messaging service is a multimedia message service.

Also, the processing can check whether a messaging address is available for the second user client, and wherein the first messaging service is a multimedia message service and the second messaging service is an instant message service.

Additionally, the first user client can have a functionality to indicate possible service applications and presence information to the user, and wherein the possible service applications and presence information can be indicated as a visual display provided to a user by employing different colors and text characters.

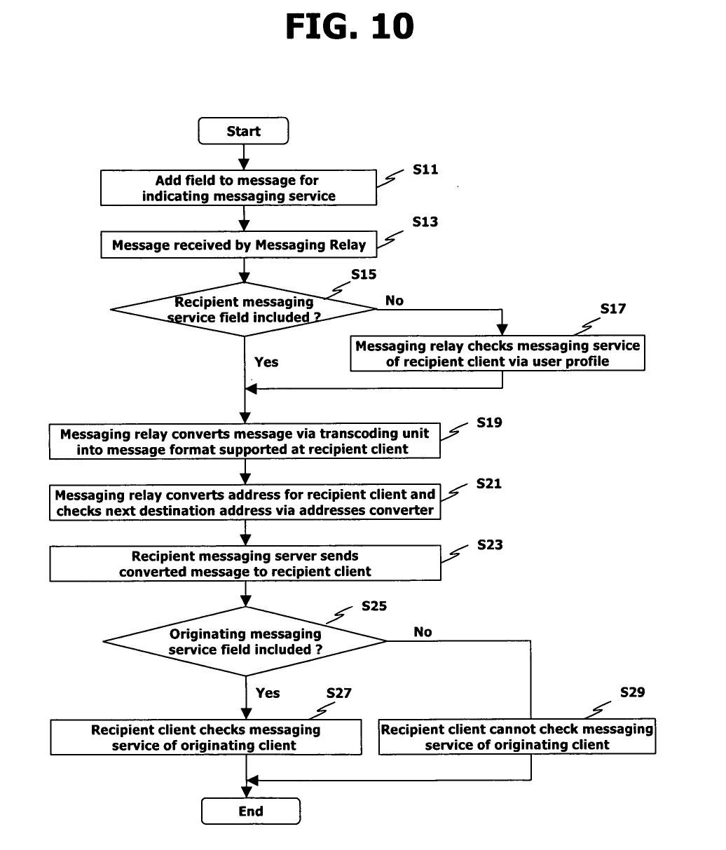

FIGS. 10 through 20 depict more specific embodiments of the present invention that pertain to the interworking by using parameters (e.q., header fields) to indicate either the originating (sending) messaging service type or the recipient (receiving) messaging service type or both.

The use of such parameters is optional, and the main advantage for employing such parameters (e.g., fields, flags, indicators, etc.) is to minimize the required signaling performed between various network elements when performing interworking between different types of messaging service systems. Also, the recipient client can be aware of the messaging service type used at the originating client in order to perform interworking of different messaging services.

In FIGS. 10 through 20, it should be noted that the use of parameters refer to using the reserve bits of the fields in the header portion of a message to specify the originating (sending) and/or the recipient (receiving) messaging service types. This “adding” of a new field does not actually increase the overall size of the header, but one or more bits that were previously reserved in the related art are used as a new field to indicate the messaging service type. Preferably, the parameters (fields, flags, indicators, etc.) can be added by the originating client, the originating messaging server, or the recipient originating service messaging server, to be described in more detail below.

FIG. 10 depicts a flow chart of a method for interworking of messaging services according to an embodiment of the present invention using a recipient messaging service field and an originating messaging service field.

A field indicating the messaging service type is added and the message is transmitted (S11), the messaging relay receives this message (S13) and checks whether a type of messaging service field is included in the message. Here, it should be noted that a recipient messaging service field and/or an originating messaging service field may be included in the message. Preferably, such fields are included into the message by the originating client or the originating messaging server or the originating messaging service interworking server.

Preferably, the messaging relay first checks whether the message contains a recipient messaging service field (S15). If not, the messaging relay checks the messaging service type desired to be received by the recipient client by referring to the user profile (S17).

If the message contains a recipient messaging service field or after the messaging service type is checked from the user profile, the messaging relay converts (changes) the message via the transcoding unit into a message format that is supported at the recipient client (S19). Then, the messaging relay converts the address of the message via the address converter into an address format that is used by the recipient messaging server and also checks the address of the next destination (S21). The address converted message is then transmitted to the recipient messaging server, which transmits the message to the recipient client (S23).

The recipient client checks to see whether an originating messaging service field exists (S25). If so, the recipient client can check the messaging service type of the originating client (S27), otherwise, the recipient client cannot perform such checking (S29). If checking can be performed, the recipient client may then transmit a reply message in response to the received message. The originating (sending) side that receives such reply (response) can then convert the messaging service format without having to check the user profile by the messaging relay. However, if an originating messaging service field does not exist, the messaging service format needs to be converted after referring to the user profile that would contain information regarding the originating messaging service type.

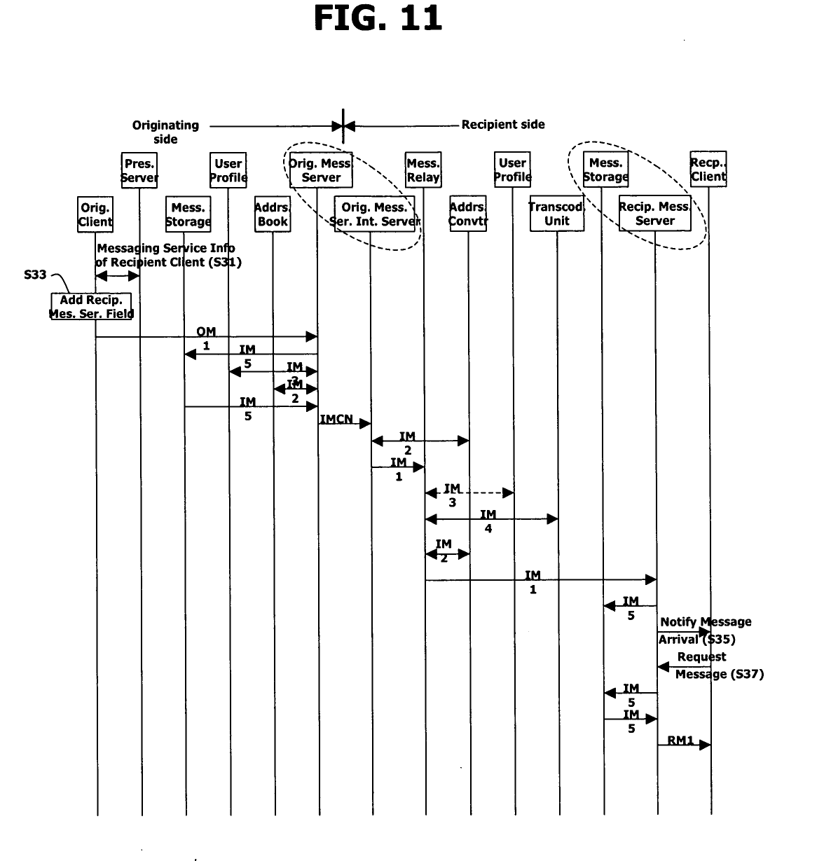

FIG. 11 depicts a signal flow for a method of interworking between respectively different messaging systems in a first embodiment of the present invention, in which the originating client inserts the recipient messaging service field.

By using an activated originating client, when a message is transmitted to a particular recipient client, the originating client checks from a presence server, the messaging service that is set at the recipient client for reception (S31), and a recipient messaging service field is included with the message (S33). Here, the recipient messaging service field is a field that indicates the type of messaging service that can currently be received by the recipient client. This can be achieved by setting one or more reserve bits in the header portion or body portion of the message, or using an indication in another portion of the message.

The message with the recipient messaging service field is then transmitted to the originating messaging server (OM1). The originating messaging server stores the received message in a message store (storage) (IM5) and checks the user profile for the information necessary in transmitting the message (IM3), and then checks the address book to determine the address of the next destination to which the message is to be sent (IM2). Then, the originating messaging server retrieves the message from the message storage (IM5) and transmits it to the originating messaging service interworking server (IMCN). Here, it should be noted that the originating messaging server and the originating messaging service interworking server may be part of a single server or may be separate servers.

The originating messaging service interworking server cooperates twith the address converter to check the next destination address of the message (IM2) and sends the message to the messaging relay for performing message service interworking (IM1). Here, the address converter can perform the same functions as those of the address book in the originating side.

The messaging relay checks the type of messaging service at the recipient client by referring to the recipient messaging service field of the message and then converts the messaging service format to be appropriate for the recipient client via the transcoding unit (IM4) If necessary (as shown by the dotted arrow line), the messaging relay may check the user profile for additional information of the recipient client other than the messaging service type (IM3).

The messaging relay cooperates with the address converter to convert the address of the recipient client included in the message into an address format that is used by the messaging service of the recipient client, and checks the address of the next destination to which the converted message should be transmitted to (IM2).

Then the messaging relay transmits the converted message to the recipient messaging server (IM1). Here, the messaging relay may temporarily store a copy of the message until the message is successfully transmitted to the recipient messaging server. The copy of the message may be stored within the messaging relay itself or in a separate storage means.

The recipient messaging server stores the received message in a message storage of the recipient messaging server (IM5), and uses a notification message to notify the recipient client that a message has arrived (S35). Here, of the necessary information for the notification message, if there is information that should be provided from the originating messaging server or the originating messaging service interworking server, then such can be received via a corresponding interface. Also, the message storage may be an internal part of the recipient messaging server or a separate entity.

Upon checking the notification message, the recipient client requests reception of the message (S37), then the recipient messaging server requests the message from the message storage (IM5), the message storage allows the message to b sent to the recipient messaging server (IM5) which then transmits the message to the recipient client (RM1).

In the above manner, a message from the originating client that uses a certain type of messaging service can be properly transmitted to the desired recipient client that uses another type of messaging service, whereby one or more messaging service parameters (e.g., fields, flags, etc.) are used to improve the signal flow among various network entities. Here, it should be noted that the above procedures may be performed in a sequence that is slightly different than that as shown, if such would be necessary or more desirable. Examples of such are shown hereafter.

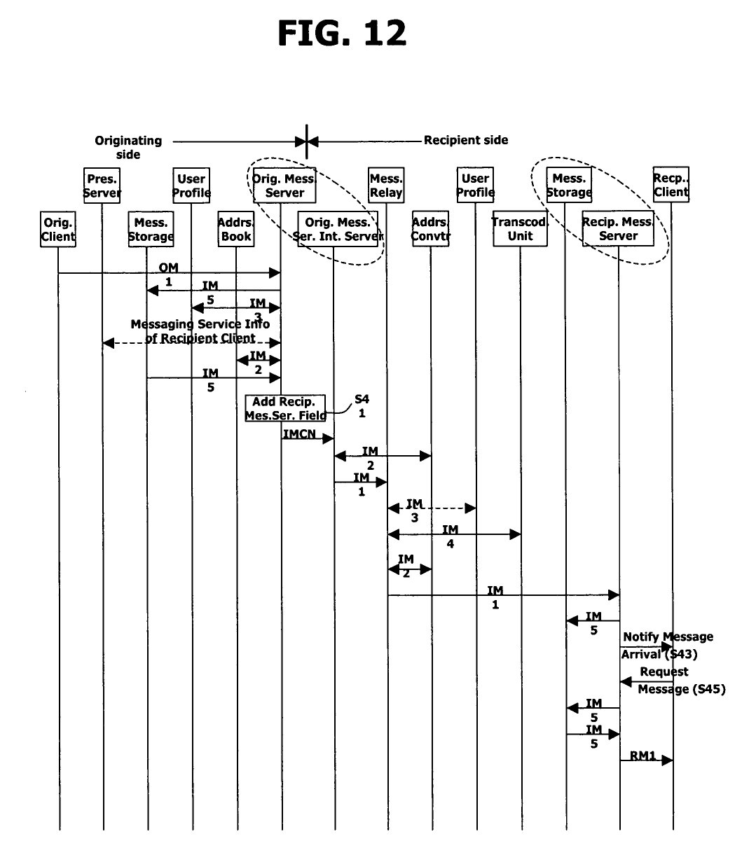

FIG. 12 depicts a signal flow for a method of interworking between respectively different messaging systems in a second embodiment of the present invention, in which the originating messaging server inserts the recipient messaging service field.

Most of the procedures are the same as those in FIG. 11, with the exception of the procedures between the originating client and the originating messaging server. Namely, the originating client does not perform steps S31 and S33 of FIG. 11. Instead, the originating messaging server can check from a presence server, the messaging service that is set at the recipient client for reception (shown by the dotted arrow line before checking the address book to determine the address of the next destination to which the message is to be sent (IM2)), and the originating messaging server includes a recipient messaging service field with the message (S41). All other subsequent steps may be the same as those in FIG. 11.

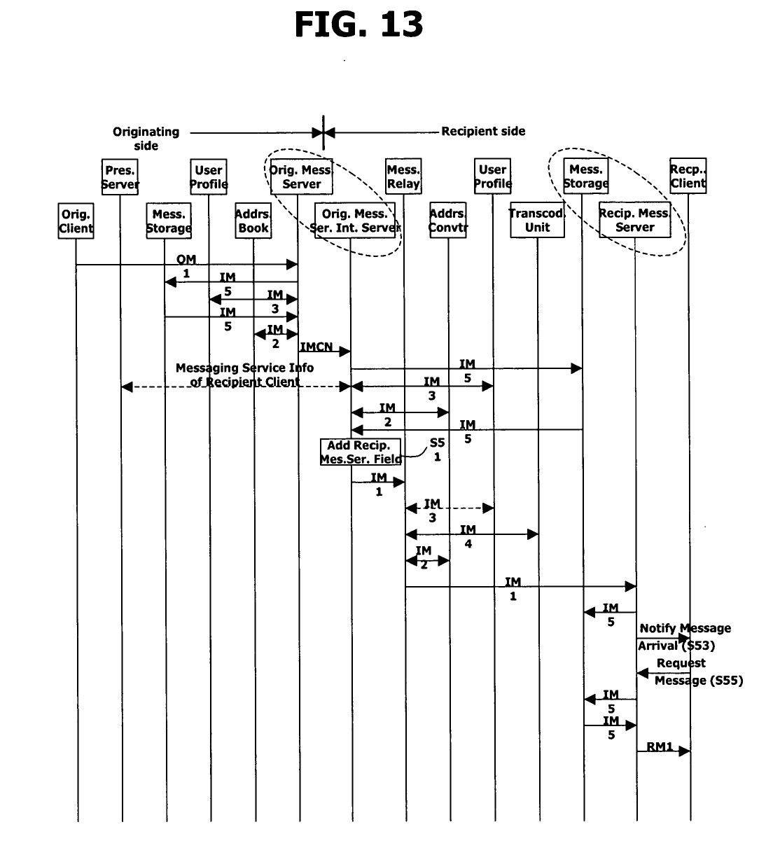

FIG. 13 depicts a signal flow for a method of interworking between respectively different messaging systems in a third embodiment of the present invention, in which the originating messaging service interworking server inserts the recipient messaging service field.

Most of the procedures are the same as those in FIG. 12. However, after the originating messaging server checks the user profile for the information necessary in transmitting the message (IM3), the originating messaging server first retrieves the message from the message storage (IM5), then checks the address book to determine the address of the next destination to which the message is to be sent (IM2), and then transmits the message to the originating messaging service interworking server (IMCN).

Thereafter, the originating messaging service interworking server can store the message into a message storage in the recipient side (IM5), and the recipient client messaging service can be checked from the user profile (IM3). Then, the originating messaging service interworking server cooperates with the address converter to check the next destination address of the message (IM2), retrieve the message form the message storage (IM5), and add a recipient messaging service field to the message (S51). All other subsequent steps may be the same as those in FIG. 11 or 12.

It should be noted that the originating messaging service interworking server (or the originating messaging server connected thereto) can also check the type of messaging service of the recipient client from the presence server (dotted line arrows) in addition to checking the user profile. Also, the recipient messaging service field may be included in the header or other portions of the message.

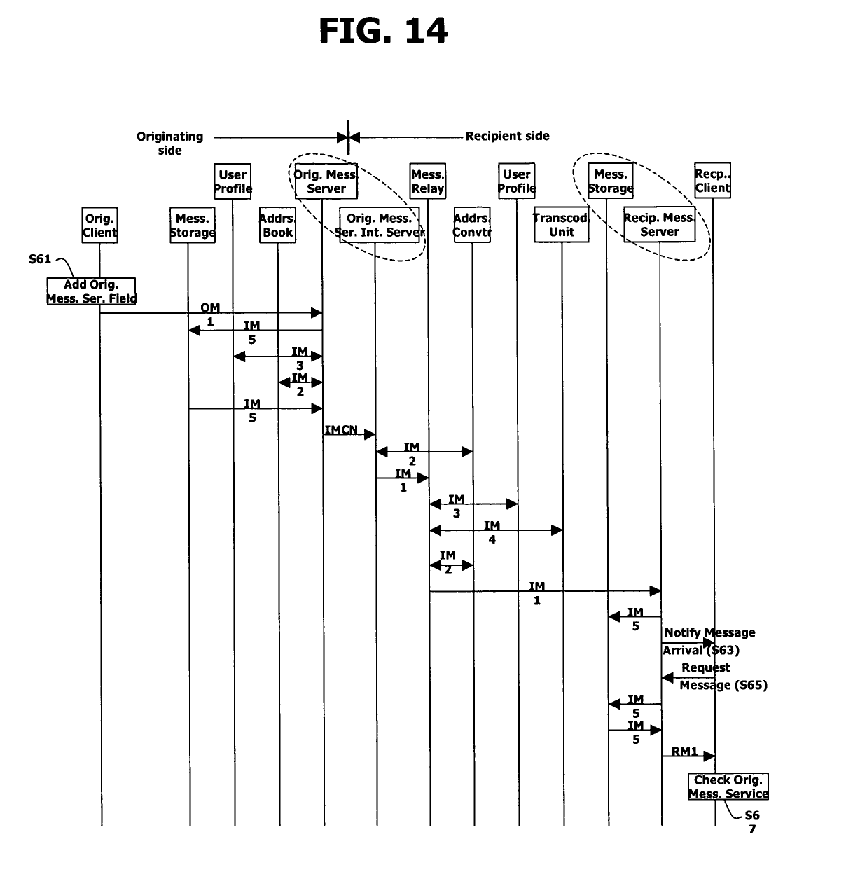

FIG. 14 depicts a signal flow for a method of interworking between respectively different messaging systems in a fourth embodiment of the present invention, in which the originating messaging server inserts the originating messaging service field.

All of the procedures can be the same as those in FIG. 11, except that the originating client adds an originating messaging service field into the message (S61) prior to performing any other steps, and the recipient client can check the type of originating messaging service (S67) at the end of the procedures. Also, instead of obtaining messaging service information of the recipient client from the presence server (S31) and the optional step of referring to the user profile at the recipient side (IM3) of FIG. 11, a presence server is not used and thus the messaging service information of the recipient client can be obtained by the messaging relay from the user profile at the recipient side (IM3).

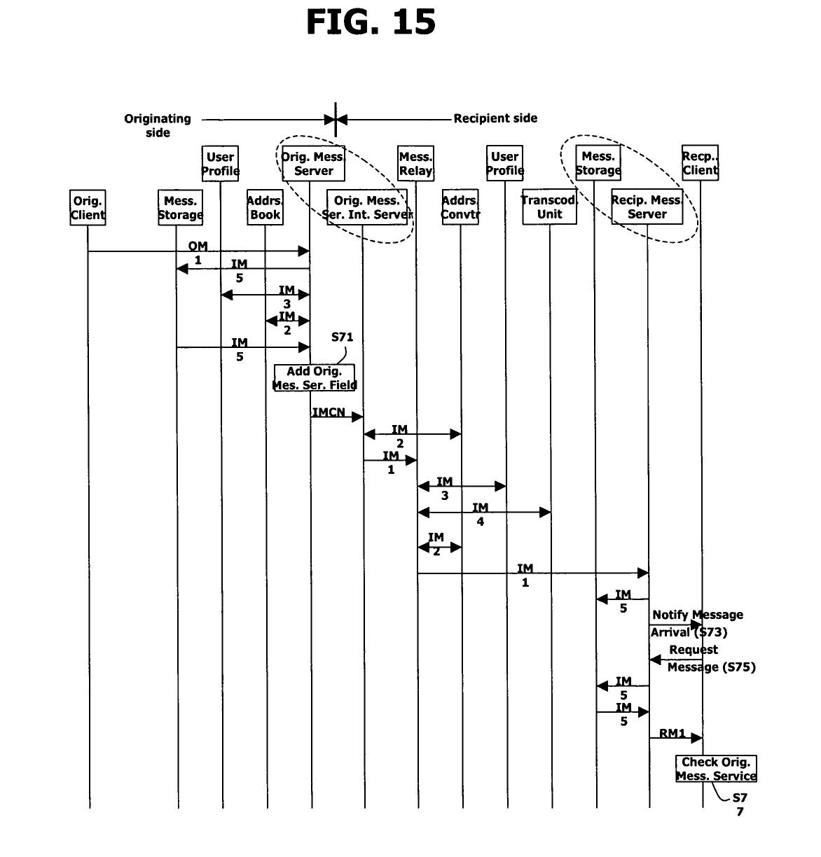

FIG. 15 depicts a signal flow for a method of interworking between respectively different messaging systems in a fifth embodiment of the present invention, in which the originating messaging server inserts the originating messaging service field.

Most of the procedures are the same as those in FIG. 14, but instead of the originating client, the originating messaging server adds an originating messaging service field to the message (S71) after performing the five initial steps (OM1, IM5, IM3, IM2, IM5) but before the step of transmitting the message (having the originating messaging service field) to the originating messaging service interworking server (IMCN).

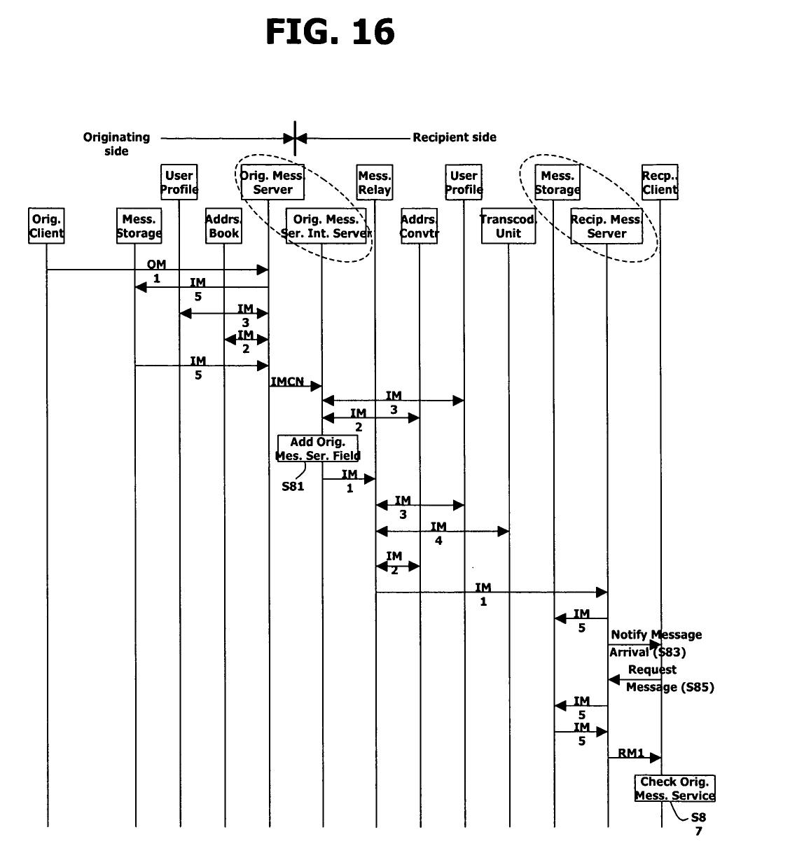

FIG. 16 depicts a signal flow for a method of interworking between respectively different messaging systems in a sixth embodiment of the present invention, in which the originating messaging service interworking server inserts the originating messaging service field.

Most of the procedures are the same as those in FIG. 15, but the originating messaging service interworking server adds an originating messaging service field to the message (S81) after receiving the message from the originating messaging server (IMCN) and cooperating with the user profile (IM3) and the address converter (IM2). All subsequent steps may be the same as those in FIG. 15.

Referring to FIGS. 11 through 16 explained above, it should be noted that certain signaling procedures depicted in different Figures may be implemented in the same procedure. Namely, certain features of FIGS. 11 through 16 may be combined or omitted if such would be desirable.

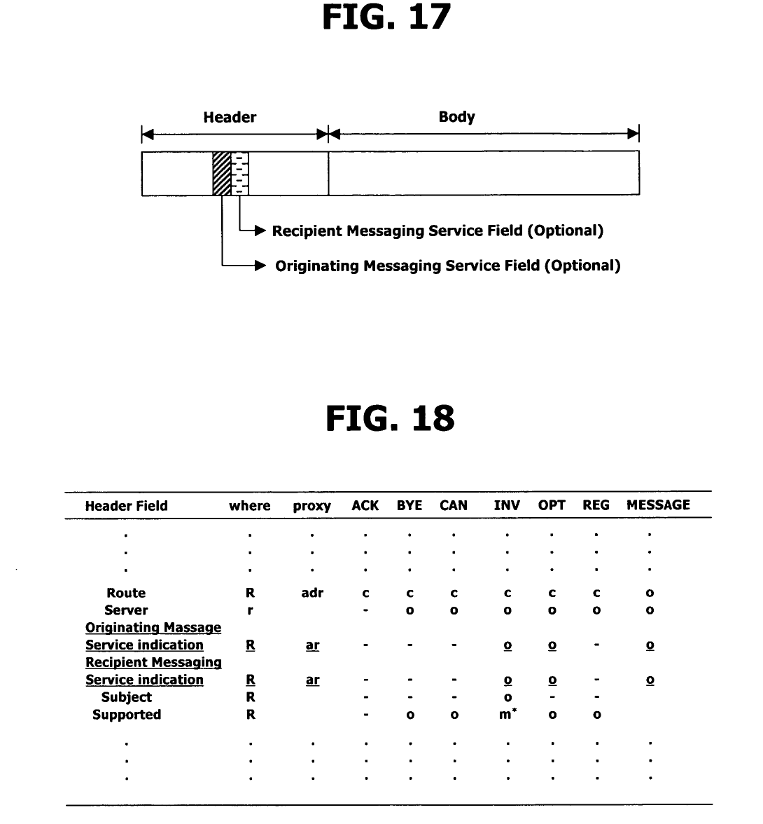

FIG. 17 depicts a format of a message having messaging service fields according to the present invention. A recipient messaging service field and a originating messaging service field may be optionally included in the header portion of a message. Alternatively, the recipient messaging service field and the originating messaging service field may be optionally included in other portions of a message, besides the header.

FIG. 18 depicts an example of a portion of a Session Initiation Protocol (SIP) message header format according to the present invention. The SIP is used during a session configuration (set up) procedure for providing services of multimedia data in real-time. In the SIP message, an invitation message (INV, INVITE) and an option field (OPT, Option Field) and a header field of the message (MESSAGE) have been newly defined to allow the originating messaging service field and the recipient messaging service field to be added thereto.

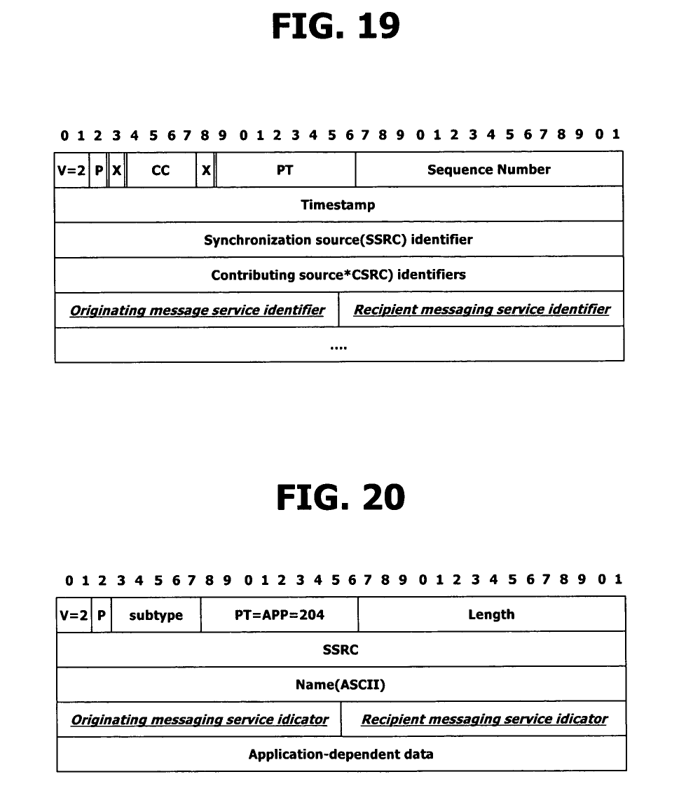

FIG. 19 depicts an example of a format for a Real-Time Protocol (RTP) message header used in transmitting multimedia data in real-time according to the present invention. The originating messaging service field and the recipient messaging service field to be added thereto.

FIG. 20 depicts an example of a format for a Real-time Transport Control Protocol (RTCP) message header used in controlling an RTP protocol according to the present invention. The originating messaging service field and the recipient messaging service field to be added to the RTCP application header. Here, length (size) of the originating messaging service field and the recipient messaging service field to be added to the RTP or RTCP may be variably adjusted accordingly.

As described above, the system and method of interworking mobile communication terminal messages according to the present invention has the effect of allowing compatibility between different messaging systems, such as an instant messaging client and a multimedia messaging service client, such that multimedia contents transmitted by using a transmitting terminal having an instant message client installed therein can be received by a receiving terminal having a multimedia message service client installed therein:

Also, the system and method of interworking mobile communication terminal messages according to the present invention has the effect of allowing a sender to use the instant message client installed in his transmitting terminal to check whether certain recipients can receive multimedia message services. Furthermore, by adding an originating messaging service field and/or a recipient messaging service field to the message, the procedures needed for verifying the messaging service type can be advantageously minimized and the signal traffic between network entities can be advantageously reduced. Also, the recipient client can be aware of the messaging service type used at the originating client in order to perform interworking of different messaging services.

The foregoing description of the preferred embodiments is provided to enable any person skilled in the art to make or use the present invention. Various modifications to these embodiments will be readily apparent to those skilled in the art, and the generic principles defined herein may be applied to other embodiments. Thus, the present invention is not intended to be limited to the embodiments shown herein but us to be accorded the widest scope consistent with the principles and novel features disclosed herein.

1. A method of interworking different messaging systems, the method comprising:
sending by a terminal to an originating messaging server, a message including a recipient preferred messaging service type;
receiving the message by a recipient originating service messaging server; and
sending a transcoded message to a recipient preferred service messaging server by considering the received message including the recipient preferred messaging service type, without checking any other network entity to get information about the recipient preferred messaging service type.

2. The method of claim 1, wherein the step of sending the message including recipient preferred messaging service type further comprises the steps of performing address resolution, checking a user profile, and storing the message prior to sending.

3. The method of claim 1, wherein the step of sending the transcoded message further comprises a step of converting the received message having a first format into a second format to allow compatibility between different types of messaging services.

4. The method of claim 1, wherein the originating messaging server receives from a presence server, state information and possible service applications related to a recipient terminal prior to sending the message including recipient preferred messaging service type.

5. The method of claim 1, wherein the recipient preferred messaging service type is indicated as a field or an indicator in the header portion or body portion of the message.

6. The method of claim 1, wherein the message further includes an originating messaging service type.

7. The method of claim 6, wherein the originating messaging service type is indicated as a field or an indicator in the header portion or body portion of the message.

8. A method of interworking different messaging systems, the method comprising:
receiving a message related to a messaging service;
obtaining preferred messaging service type of a recipient;
inserting in the received message, at least one parameter related to the obtained preferred messaging service type; and
sending the received message having the parameter inserted therein to a recipient originating service messaging server.

9. The method of claim 8, further comprising a step of finding a destination messaging system which the received message should be routed to.

10. The method of claim 8, wherein the preferred messaging service type is obtained from a presence server or a user profile.

11. The method of claim 8, wherein the at least one parameter is for sending or receiving a message of the preferred messaging service.

12. The method of claim 8, wherein the at least one parameter includes one parameter for sending a message of the preferred messaging service and another parameter for receiving a message of the preferred messaging service.

13. The method of claim 8, wherein the recipient preferred messaging service type is indicated as a field or an indicator in the header portion or body portion of the message.

14. The method of claim 8, wherein the message further includes a parameter indicating an originating messaging service type.

15. The method of claim 14, wherein the originating messaging service type is indicated as a field or an indicator in the header portion or body portion of the message.

16. A method of interworking different messaging systems, the method comprising:
receiving a message having a parameter therein that indicates a preferred messaging service type;
processing the message according to the parameter into a format supported by the preferred messaging service; and
providing the message to a recipient of the preferred messaging service.

17. The method of claim 16, wherein the message is received by a recipient originating service messaging server in a format that is different from the format of the preferred messaging service.

18. The method of claim 16, wherein the processing step includes a step of performing address resolution.

19. The method of claim 18, wherein the messages are processed via a messaging relay for checking of a user profile, performing content and header transcoding, and storing the messages.

20. The method of claim 16, wherein the messages is provided to the recipient via a recipient preferred service messaging server.

21. The method of claim 16, wherein the parameter is indicated as a field or an indicator in the header portion or body portion of the message.

22. The method of claim 16, wherein the parameter further indicates an originating messaging service type.

23. The method of claim 22, wherein the originating messaging service type is indicated as a field or an indicator in the header portion or body portion of the message.

24. A messaging service method, comprising:
sending a message from an originating client to an originating messaging server;
storing the message in a message storage;
obtaining user information by referring to an indicator associated with the message or by referring to a presence server or a user profile, wherein the information contains at least a preferred messaging service type;
finding a next server through address resolution;
sending the message to the next server;
transcoding an originating message format into a recipient message format;
finding a recipient preferred service messaging server through address resolution;
sending the transcoded message to the recipient preferred service messaging server;
storing the transcoded message and sending a notification to the recipient client;
requesting to receive the transcoded message to the recipient preferred service messaging server; and
receiving the transcoded message.

25. A messaging service method comprising:
receiving by a first messaging service server, a multimedia message sent by a first user client of a first messaging service;
processing the multimedia message at the first messaging service server and at a second messaging service server; and
providing by the second messaging service server, the processed multimedia message to a second user client of a second messaging service.

26. The method of claim 25, wherein the processing modifies the contents or the format of the multimedia message to allow compatibility between the first and second messaging services.

27. The method of claim 26, wherein the first messaging service is an instant message service and the second messaging service is a multimedia message service.

28. The method of claim 25, wherein the processing checks whether a messaging address is available for the second user client.

29. The method of claim 28, wherein the first messaging service is a multimedia message service and the second messaging service is an instant message service.

30. The method of claim 26, wherein the first user client has a functionality to indicate possible service applications and presence information to the user.

31. The method of claim 20, wherein the possible service applications and presence information are indicated as a visual display provided to a user by employing different colors and text characters.

32. The method of claim 25, wherein the processing step comprises inserting a first parameter that indicates a recipient messaging service type.

33. The method of claim 32, wherein the recipient messaging service type is indicated as a field or an indicator in the header portion or body portion of the multimedia message.

34. The method of claim 33, wherein the processing step comprises inserting a second parameter that indicates an originating messaging service type.

35. The method of claim 34, wherein the originating messaging service type is indicated as a field or an indicator in the header portion or body portion of the multimedia message.

36. A messaging service method comprising:
receiving a message sent from a sending terminal to be delivered to a receiving terminal;
checking whether at least one indicator that indicates a type of messaging service is included with the message;
converting the message into a format supported by the receiving terminal based upon the indicator; and
transmitting the converted message to the receiving terminal.

37. The method of claim 36, wherein a first indicator indicates the type of messaging service of the receiving terminal.

38. The method of claim 37, wherein information regarding the type of messaging service of the receiving terminal is also obtained from a presence server.

39. The method of claim 37, wherein first indicator is a field or a flag in the header portion or body portion of the message.

40. The method of claim 37, wherein a second indicator indicates the type of messaging service of the sending terminal.

41. The method of claim 40, wherein second indicator is a field or a flag in the header portion or body portion of the message.

42. The method of claim 36, wherein the at least one indicator is included with the message by a sending client in the sending terminal.

43. The method of claim 36, wherein the at least one indicator is included with the message by a server that is part of the sending side of a network.

44. The method of claim 36, wherein the at least one indicator is included with the message by a server that is part of the receiving side of a network.
